(19) United States
(12) Patent Application Publication
(10) Pub. No.: US 2017/0018877 A1
(43) Pub. Date: Jan. 19, 2017

(54) CORD CONTROL APPARATUS

(71) Applicant: Alexander J. Sacha, Park Ridge, IL (US)

(72) Inventor: Alexander J. Sacha, Park Ridge, IL (US)

(21) Appl. No.: 15/200,177

(22) Filed: Jul. 1, 2016

Related U.S. Application Data
(60) Provisional application No. 62/191,581, filed on Jul. 13, 2015.

(51) Int. Cl. H01R 13/639

(52) U.S. Cl. CPC H01R 13/6392

(57) ABSTRACT

The present invention is a cord control apparatus including a cord restraint assembly extending from a plug. The plug is connected to a first end of an electrical cord. The cord restraint assembly is made up of an inner wire core covered by a flexible outer insulation layer. Terminating and interface caps cover the respective distal and proximal ends of the inner wire core and flexible outer insulation layer. A second attachment contour extending from the interface cap is removably connected to a first attachment contour in the plug and connects the cord restraint assembly and plug. The core is deformable and the coating is flexible, allowing the cord restraint assembly to be reconfigured into different shapes as needed by a user. This enables a user to easily connect the plug or electrical cord to other devices and structures, or to raise part of the plug or electrical cord to a required height.

### CROSS-REFERENCE TO RELATED APPLICATIONS

This patent application claims the benefit of U.S. Provisional Application No. 62/191,581 filed Jul. 13, 2015. The above application is incorporated by reference herein in its entirety.

### FIELD OF INVENTION

This invention relates to the field of electrical connectors and more specifically to an electrical connector having an attached control apparatus.

### BACKGROUND OF THE INVENTION

Electrical extension cords are commonly found on construction and remodeling sites, outdoors, garages, and other locations with limited access to electrical power sockets. The cords allow a user to extend the range at which they can use electrical tools. Unfortunately, electrical extension cords also have several well-known problems.

Extension cords can tangle during use or storage, shortening the overall extension cord length and potentially damaging the extension cords. If an extension cord detaches from a tool, the tool will stop functioning and the user will have to reach the extension cord to plug the tool back in. This may be complicated and even hazardous if the user is in a remote or elevated location, such as a tree or roof. Furthermore, while climbing to reach such areas, a user may need to use one hand to bring the extension cord up with them, which can also risk their safety. Additionally, extension cords running along the ground may find the plug ends in standing water, producing an electrical safety hazard.

Ad hoc solutions, such as tying two electrical cords together or wrapping part of the cord around a wound length, can damage the cord, leading to safety issues. Prior art inventions have solved these problems individually with separate apparatuses, but have not developed a single apparatus capable of preventing tangling, preventing unplugging, attaching to a structure, and raising a plug from the ground. For example, plastic ties are capable of attaching an extension cord to the plug of a power tool, but cannot raise the extension cord out of water.

There is an unmet need in the art for a multi-functional extension cord control apparatus.

### BRIEF SUMMARY OF THE INVENTION

The present invention is a cord control apparatus including a cord restraint assembly extending from a plug. The plug is connected to a first end of an electrical cord. The cord restraint assembly is made up of an inner wire core covered by a flexible outer insulation layer. The inner wire core is deformable, allowing the cord restraint assembly to be reconfigured into many different shapes as needed by a user. Terminating and interface caps cover the respective distal and proximal ends of the inner wire core and flexible outer insulation layer. A second attachment contour extending from the interface cap is removably connected to a plug cavity on the plug through a contoured attachment interface. The contoured attachment interface is made up of removably mated cavity and protrusion connectors. One of the cavity or protrusion connectors is located on the second attachment contour while the other is located on the first attachment contour. This serves to connect the cord restraint assembly and plug.

### BRIEF DESCRIPTION OF SEVERAL VIEWS OF THE DRAWING(S)

FIG. 1a illustrates cross-sectional and sectional magnified views of an exemplary embodiment of a cord control apparatus.

FIGS. 1b and 1c illustrate cross-sectional and frontal views, respectively, of an exemplary embodiment of a plug.

FIGS. 1d and 1e illustrate cross-sectional views of an exemplary embodiment of a cord restraint assembly.

### TERMS OF ART

As used herein, the term “cavity connector” refers to a female connection capable of receiving a protrusion connector and having either a blind configuration or at least two walls.

As used herein, the term “contour” refers to a rounded or angular depression or protrusion adapted to receive or be received by another contour to form an interlocking interface.

As used herein, the term “distal” refers to a point situated away from a given point.

As used herein, the term “flexible” refers to a material capable of bending without breaking.

As used herein, the term “insulation” refers to a material having a resistivity of at least 1.00×10¹¹ ρ (Ω*m).

As used herein, the term “protrusion connector” refers to a male connection capable of being received by a cavity connector.

As used herein, the term “proximal” refers to a point situated nearer to a given point.

As used herein, the term “wire” refers to a flexible length of metallic and/or polymeric material or materials that retains a deformed configuration.

### DETAILED DESCRIPTION OF THE INVENTION

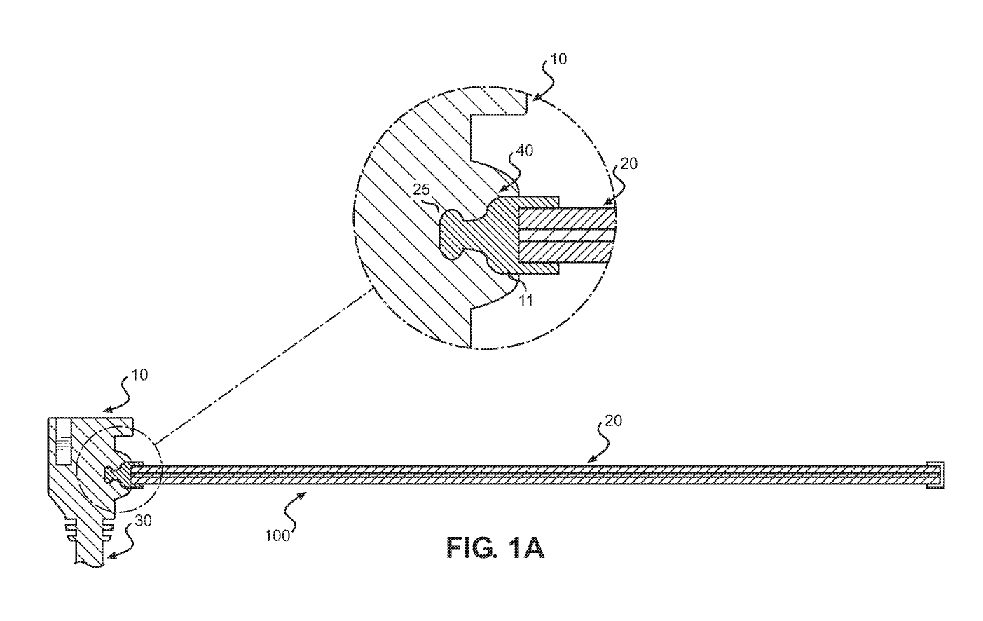

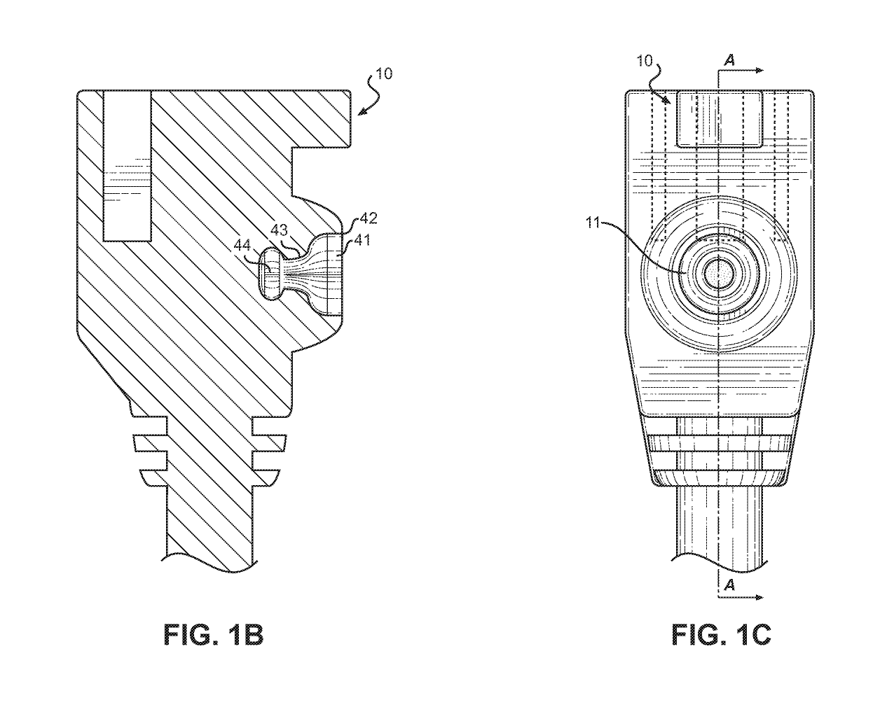

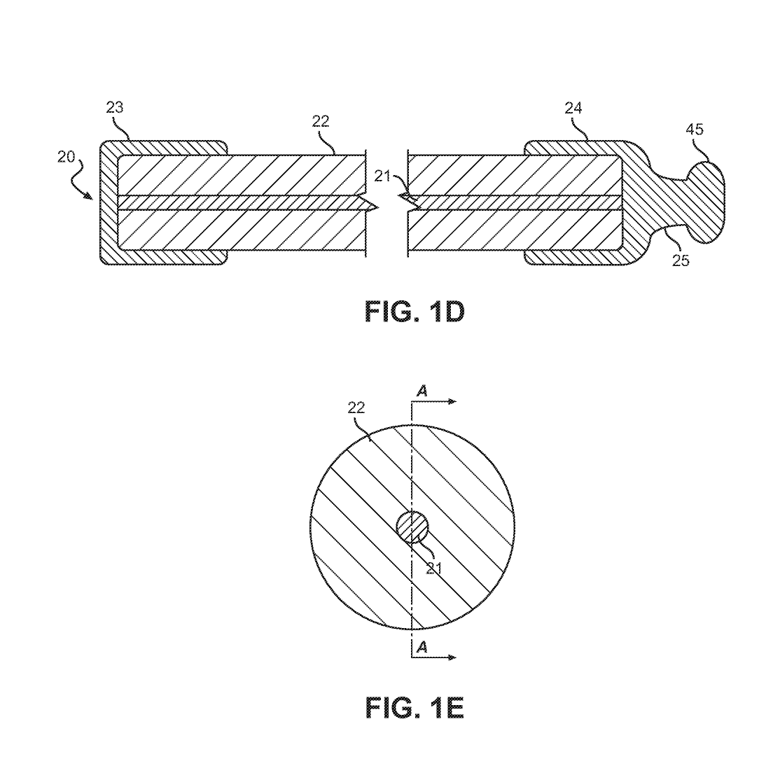

FIG. 1a illustrates cross-sectional and sectional magnified views of an exemplary embodiment of cord control apparatus 100. FIGS. 1b and 1c illustrate cross-sectional and frontal views, respectively, of an exemplary embodiment of plug 10. FIGS. 1d and 1e illustrate cross-sectional views of an exemplary embodiment of cord restraint assembly 20.

Cord control apparatus 100 includes plug 10 which removably receives cord restraint assembly 20 and is connected to electrical cord 30. Cord restraint assembly 20 is removable from plug 10 to allow replacement of cord restraint assembly 20 if damaged or removal of cord restraint assembly 20 if unnecessary. Electrical cord 30 is an electrically conducting connection having an electrically insulating safety coating, as is commonly known in the art. In certain embodiments, plug bodies 10 and cord restraint assemblies 20 are located at both ends of electrical cord 30.

Plug 10 is formed and manufactured as is commonly known in the art. In the exemplary embodiment, plug 10 is a female socket for receiving at least one three-pronged male electrical plug. In other embodiments, plug 10 may be a two- or three-pronged male electrical plug or a female socket for receiving at least one two-pronged male electrical plug. Plug 10 includes a first attachment contour 11 which connects to one end of cord restraint assembly 20. First attachment contour 11 may be located on any side of plug 10 that cord restraint assembly 20 does not interfere with use of plug 10. Plug 10 is manufactured of a semi-rigid, insulating material, such as, but not limited to, a molded polymer. This material is capable of slight deformation to removably connect to one end of cord restraint assembly 20 while preventing inadvertent removal of cord restraint assembly 20.

In the exemplary embodiment, cord restraint assembly 20 has a circular cross-section and an overall cylindrical configuration. In other embodiments, cord restraint assembly 20 has a triangular, square, rectangular, or substantially flat cross-section. In the exemplary embodiment, cord restraint assembly 20 has a straight linear configuration until deformed. In other embodiments, cord restraint assembly 20 may have a single-loop, multiple-loop, figure-eight, helical, rectangular, or triangular configuration. In the exemplary embodiment, cord restraint assembly 20 has a diameter approximately equal to that of electrical cord 30. In other embodiments, cord restraint assembly 20 has a diameter smaller than that of electrical cord 30. In the exemplary embodiment, cord restraint assembly 20 has a length of approximately 4 inches to approximately 18 inches.

Cord restraint assembly 20 includes an inner wire core 21 covered by a flexible outer insulation layer 22. Inner wire core 21 is made from a deformable material, capable of retaining its deformed shape. In the exemplary embodiment, inner wire core 21 is a metallic wire, such as, but not limited to, steel, aluminum, or copper. In other embodiments, inner wire core 21 may be a plurality of inner wire core components, such as multiple braided or bundled wires. In still other embodiments, inner wire core 21 may be manufactured from a polymeric material or from a combination of materials. Inner wire core 21 is completely electrically insulated from any electrically conductive elements in either plug 10 or electrical cord 30.

Flexible outer insulation layer 22 is both flexible and insulating. In the exemplary embodiment, flexible outer insulation layer 22 is a silicone polymer. In other embodiments, flexible outer insulation layer 22 may be any flexible electrically insulating material such as, but not limited to, other polymers, elastomers, foams, composites, adhesives, or any combination thereof. Flexible outer insulation layer 22 may also include multiple layers of the same or different materials. The combination of inner wire core 21 and flexible outer insulation layer 22 may be manufactured by an extrusion process. Flexible outer insulation layer 22 need not evenly cover inner wire core 21, so long as inner wire core 21 remains completely covered and electrically insulated.

Cord restraint assembly 20 also includes a terminating cap 23 and an interface cap 24. Terminating cap 23 and interface cap 24 cover the distal and proximal ends, respectively, of inner wire core 21 and flexible outer insulation layer 22. In the exemplary embodiment, terminating cap 23 and interface cap 24 also partially extend over an external surface of flexible outer insulation layer 22 to reduce the likelihood of separation. Terminating cap 23 and interface cap 24 provide additional protection to the ends of cord restraint assembly 20 and help to prevent inner wire core 21 from protruding from flexible outer insulation layer 22. Inner wire core 21 is completely covered and electrically insulated by the combination of flexible outer insulation layer 22, terminating cap 23, and interface cap 24.

Interface cap 24 also includes a second attachment contour 25 extending proximally from interface cap 24 and forming a connection with first attachment contour 11. Interface cap 24 and second attachment contour 25 are manufactured of a semi-rigid, insulating material, such as, but not limited to, a molded polymer. This material is capable of slight deformation to allow removable connection between first attachment contour 11 and second attachment contour 25, while still preventing inadvertent removal.

In the exemplary embodiment, cord restraint assembly 20 is deformable at any point between terminating cap 23 and interface cap 24. In some embodiments, cord restraint assembly 20 is only deformable in certain locations to encourage certain uses or configurations.

Contoured attachment interface 40 is made up of a cavity connector 41 which mates with a protrusion connector 45. In the exemplary embodiment, cavity connector 41 is first attachment contour 11 and protrusion connector 45 is second attachment contour 25. In other embodiments, this configuration may be reversed.

Cavity connector 41 includes a cavity rim 42 and a cavity neck 43. Cavity rim 42 forms an edge leading to cavity connector 41. Cavity rim 42 may be chamfered or rounded to reduce wear and/or abrasion damage to plug 10 or cord restraint assembly 20. Cavity neck 43 is a narrowing of a section of cavity connector 41. In the exemplary embodiment, cavity neck 43 leads to a cavity chamber 44, which is dimensioned to allow formation of an interlocking connection with protrusion connector 45. In the exemplary embodiment, the inner dimensions of cavity chamber 44 are approximately identical to the outer dimensions of protrusion connector 45. In other embodiments, the inner dimensions of cavity chamber 44 are large enough to accommodate different protrusion connectors 45 with differing outer dimensions. In another embodiment, cavity neck 43 is dimensioned to allow formation of an interference or friction fit with protrusion connector 45.

In use, cord restraint assembly 20 may removably connect plug 10 and electrical cord 30 to a stationary object such as a ladder, tree, or article of furniture. Cord restraint assembly 20 may also maintain a removable connection between a first plug 10 and a second plug 10 by extending or winding around the second plug 10 or a second electrical cord 30. A user may deform cord restraint assembly 20 to raise plug 10 and/or at least part of electrical cord 30 off of a surface or wrap cord restraint assembly 20 around an at least partially wound electrical cord 30 to hold electrical cord 30 in place.

It will be understood that many additional changes in the details, materials, procedures and arrangement of parts, which have been herein described and illustrated to explain the nature of the invention, may be made by those skilled in the art within the principle and scope of the invention as expressed in the appended claims.

It should be further understood that the drawings are not necessarily to scale; instead, emphasis has been placed upon illustrating the principles of the invention. Moreover, the terms “about,” “substantially” or “approximately” as used herein may be applied to modify any quantitative representation that could permissibly vary without resulting in a change in the basic function to which it is related.

What is claimed is:

1. A cord control apparatus, comprising:
a plug having a first attachment contour;
a cord restraint assembly comprised of
an inner wire core;
a flexible outer insulation layer;
a terminating cap affixed to a distal end of said inner wire core and a distal end of said flexible outer insulation layer;
an interface cap having a second attachment contour, wherein said interface cap is affixed to a proximal end of said inner wire core and a proximal end of said flexible outer insulation layer;
wherein said cord restraint assembly is removably attached to said plug by at least one contoured attachment interface formed by said first attachment contour and said second attachment contour.

2. The apparatus of claim 1, wherein said at least one contoured attachment interface has at least one cavity connector, wherein said cavity connector is configured to removably mate with at least one protrusion connector.

3. The apparatus of claim 2, further including a cavity rim forming an interface with said cavity connector, wherein said cavity rim is chamfered or rounded.

4. The apparatus of claim 2, further including a cavity neck located within said cavity connector.

5. The apparatus of claim 4, wherein said cavity neck forms an interference fit with said protrusion connector.

6. The apparatus of claim 4, further including a cavity chamber located adjacent to said cavity neck.

7. The apparatus of claim 6, wherein said cavity neck forms an interlocking connection with said protrusion connector.

8. The apparatus of claim 2, wherein said cavity connector is said first attachment contour and said protrusion connector is said second attachment contour.

9. The apparatus of claim 2, wherein said protrusion connector is said first attachment contour and said cavity connector is said second attachment contour.

10. The apparatus of claim 1, wherein said at least one cord restraint assembly has a cross-sectional shape selected from the group consisting of: substantially circular, triangular, square, rectangular, or substantially flat.

11. The apparatus of claim 1, wherein said at least one cord restraint assembly has a non-deformed configuration selected from the group consisting of: straight linear, single-loop, multiple-loop, figure-eight, helical, rectangular, and triangular.

12. The apparatus of claim 1, wherein said inner wire core is made up of a plurality of inner wire core components.

13. The apparatus of claim 1, wherein said interface cap and said terminating cap extend at least partially along an outer surface of said flexible outer insulation layer.

14. The apparatus of claim 1, wherein said inner wire core is completely covered by said flexible outer insulation layer, said interface cap, and said terminating cap.

15. The apparatus of claim 1, wherein said inner wire core is selected from the group consisting of: a metallic material, a polymeric material, and a combination thereof.

16. The apparatus of claim 15, wherein said inner wire core is a metallic material selected from the group consisting of: steel, copper, and aluminum.

17. The apparatus of claim 1, wherein said flexible outer insulation layer is selected from the group consisting of: polymers, elastomers, foams, composites, adhesives, and any combination thereof.

18. The apparatus of claim 1, wherein said plug, said interface cap, and said terminating cap are a semi-rigid, insulating material.

19. The apparatus of claim 1, wherein said at least one cord restraint assembly is at least partially manufactured by an extruding process.

20. The apparatus of claim 1, wherein said plug is connected to a first end of an electrical cord and a second plug is connected to a second end of said electrical cord, wherein a second cord restraint assembly extends from said second plug.
